(19) United States
(12) Patent Application Publication
(10) Pub. No.: US 2026/0300230 A1
(43) Pub. Date: Oct. 1, 2026

(54) LOG COMPRESSION AND RECOVERY

(71) Applicant: INTERNATIONAL BUSINESS MACHINES CORPORATION, Armonk, NY (US)

(72) Inventors: Hui Wang, BEIJING (CN); Mai Zeng, BEIJING (CN); Peng Hui Jiang, Beijing (CN); Yu Mei Dai, Beijing (CN); Xiang Yu Xue, Rizhao (CN); Wei Li, BEIJING (CN); Xiao Chen Huang, Beijing (CN)

(21) Appl. No.: 19/092,461

(22) Filed: Mar. 27, 2025

(51) Int. Cl. G06F 16/174

(52) U.S. Cl. CPC G06F 16/1744

(57) ABSTRACT

Embodiments receive raw data from an external application, create structured log data by removing noise from the received raw data, perform event merging on the structured log data, perform pattern extraction on the event merged structured log data, create sparse log data by performing field reduction on the pattern extraction, create compressed logs by applying a first set of large language model (LLM) compression on the sparse log data, and create recovered logs by applying a second set of LLM recovery on the compressed logs.

### BACKGROUND

Aspects of the present invention relate generally to log compression and recovery and, more particularly, to performing log compression and recovery using sparsity processing and a large language model (LLM).

A mainframe operating system can be a secure and scalable operating system.

Accordingly, the mainframe operating system supports a wide range of workloads and includes log data, such as syslog and operlog. The log data is used for monitoring system activities, diagnosing issues, and ensuring compliance with operational protocols within the mainframe operating system.

### SUMMARY

In a first aspect of the invention, there is a method including: receiving raw data from an external application, creating structured log data by removing noise from the received raw data, performing event merging on the structured log data, performing pattern extraction on the event merged structured log data, creating sparse log data by performing field reduction on the pattern extraction, creating compressed logs by applying a first set of large language model (LLM) compression on the sparse log data, and creating recovered logs by applying a second set of LLM recovery on the compressed logs.

In another aspect of the invention, there is a computer program product comprising one or more computer-readable storage media and program instructions stored on the one or more computer-readable storage media to perform operations comprising: receiving raw data from an external application, creating structured log data by removing noise from the received raw data, performing event merging on the structured log data, performing pattern extraction on the event merged structured log data, creating sparse log data by performing field reduction on the pattern extraction, creating compressed logs by applying a first set of large language model (LLM) compression on the sparse log data, and creating recovered logs by applying a second set of LLM recovery on the compressed logs.

In another aspect of the invention, there is a computer system comprising a processor set, one or more computer-readable storage media, and program instructions stored on the one or more computer-readable storage media to cause the processor set to perform operations comprising: receiving raw data from an external application; creating a first set of structured log data by removing noise from the received raw data; performing event merging on the first set of structured log data; performing pattern extraction on the event merged first set of structured log data; creating sparse log data by performing field reduction on the pattern extraction; creating compressed logs by applying a first set of large language model (LLM) compression on the sparse log data; creating a second set of structured log data by extracting key components and organization data of the compressed logs; and creating recovered logs by applying a second set of LLM recovery on the second set of structured log data.

### BRIEF DESCRIPTION OF THE DRAWINGS

Aspects of the present invention are described in the detailed description which follows, in reference to the noted plurality of drawings by way of non-limiting examples of exemplary embodiments of the present invention.

FIG. 1 depicts a computing environment according to an embodiment of the present invention.

FIG. 2 shows a block diagram of an exemplary environment of a log compression server in accordance with aspects of the present invention.

FIG. 3 shows a block diagram of an exemplary environment of a log recovery server in accordance with aspects of the present invention.

FIG. 4 shows a flowchart of an exemplary method of the log compression server in accordance with aspects of the present invention.

FIG. 5 shows a flowchart of an exemplary method of the log recovery server in accordance with aspects of the present invention.

FIG. 6 shows a flowchart of an exemplary method of the log compression server in accordance with aspects of the present invention.

FIG. 7 shows a flowchart of an exemplary method of the log recovery server in accordance with aspects of the present invention.

FIG. 8 shows a flowchart of an exemplary method of the log compression server in accordance with aspects of the present invention.

FIG. 9 shows a flowchart of an exemplary method of the log recovery server in accordance with aspects of the present invention.

FIG. 10 shows an event merging example in accordance with aspects of the present invention.

FIG. 11 shows a pattern extraction example in accordance with aspects of the present invention.

FIG. 12 shows a field reduction example in accordance with aspects of the present invention.

FIG. 13 shows an example of compression in accordance with aspects of the present invention.

FIG. 14 shows an example of recovery in accordance with aspects of the present invention.

FIG. 15 shows an example of compression and recovery in accordance with aspects of the present invention.

### DETAILED DESCRIPTION

Aspects of the present invention relate generally log compression and recovery and, more particularly, to performing log compression and recovery using sparsity processing and a large language model (LLM). In embodiments of the present invention, the system, methods, and computer program products compress log data to reduce storage requirements and manage the log data. In further embodiments, the systems, methods, and computer program products compress the log data such that the log data can be easily recovered without losing any data.

In a first aspect of the present invention, there is a method including: receiving raw data from an external application; creating structured log data by removing noise from the received raw data; performing event merging of the created structured log data; performing pattern extraction on the event merged structured log data; creating sparse log data by performing field reduction on the pattern extraction; creating compressed logs by applying a first set of LLM compression on the sparse log data; and creating recovered logs by applying a second set of LLM recovery on the compressed logs. In particular, embodiments provide a technical improvement of efficiently compressing, managing, and recovering log data using sparsity processing and LLM techniques.

The method may also include the external application including a software application. In particular, embodiments may improve compressing raw data by utilizing a software application to send the raw data for compression.

The method may also include the raw data including log data. In particular, embodiments may improve compressing log data by receiving the log data for compression.

The method may also include the log data including syslog data. In particular, embodiments may improve compressing syslog data by receiving the syslog data for compression.

The method may also include the log data including operlog data. In particular, embodiments may improve compressing operlog data by receiving the operlog data for compression.

The method may also include extracting at least one of a timestamp, a log level, and a message from the received raw data. In particular, embodiments may extract at least one of a timestamp, a log level, and a message from the received raw data such that the extracted at least one of the timestamp, the log level, and the message is utilized to apply LLM compression to improve compression of log data.

The method may also include the performing the event merging of the structured log data including detecting and combining duplicate events within the structured log data. In particular, embodiments may combine duplicate events within the structured log data to improve compression of log data by removing duplicate events.

The method may also include the removing noise from the received raw data including removing the noise from the received raw data by filtering using moving averages and a median filter. In particular, embodiments may improve compression of the structured log data by removing noise by filtering the received raw data.

The method may also include the pattern extraction including identifying recurring log patterns from text within log entries of the event merged structured log data. In particular, embodiments may improve compression of the event merged structured log data by identifying recurring log patterns from text within log entries for removal.

The method may also include the performing the field reduction on the pattern extraction including removing redundant fields from the pattern extraction. In particular, embodiments may improve compression of the pattern extraction by removing redundant fields.

The method may also include the creating the compressed logs by applying the first set of LLM compression comprises utilizing a first LLM model on the sparse log data. In particular, embodiments may improve compression of the logs by applying the first set of LLM compression and utilizing a first LLM model.

The method may also include the first LLM including a generalized language model (GLM). In particular, embodiments may improve compression of the logs by utilizing a GLM.

The method may also include the creating the recovered logs by applying the second set of LLM recovery comprises utilizing a second LLM model on the compressed logs. In particular, embodiments may improve recovery of the logs by applying the second set of LLM recovery and utilizing a second LLM model.

The method may also include the second LLM including a generalized language model (GLM). In particular, embodiments may improve recovery of the logs by utilizing a GLM.

In another aspect of the invention, there is a computer program product comprising one or more computer-readable storage media and program instructions stored on the one or more computer-readable storage media to perform operations comprising: receiving raw data from an external application; creating structured log data by removing noise from the received raw data; performing event merging of the created structured log data; performing pattern extraction on the event merged structured log data; creating sparse log data by performing field reduction on the pattern extraction; creating compressed logs by applying a first set of LLM compression on the sparse log data; and creating recovered logs by applying a second set of LLM recovery on the compressed logs. In particular, embodiments provide a technical improvement of efficiently compressing, managing, and recovering log data using sparsity processing and LLM techniques.

The computer program product may also include the performing the event merging of the structured log data including detecting and combining duplicate events within the created structured log data. In particular, embodiments may combine duplicate events within the structured log data to improve compression of log data by removing duplicate events.

The computer program product may also include the removing noise from the received raw data including removing the noise from the received raw data by filtering using moving averages and a median filter. In particular, embodiments may improve compression of the structured log data by removing noise by filtering the received raw data.

The computer program product may also include the performing the pattern extraction including identifying recurring log patterns from text within log entries of the event merged structured log data and the performing the field reduction on the pattern extraction including removing redundant fields on the pattern extraction. In particular, embodiments may improve compression of the event merged structured log data by identifying recurring log patterns from text within log entries and removing redundant fields.

The computer program product may also include the creating the compressed logs including utilizing a first LLM for creating the compressed logs and the creating the recovered logs including utilizing a second LLM model for creating the recovered logs. In particular, embodiments may improve compression of the logs by applying the first set of LLM compression and utilizing a first LLM model and may improve recovery of the logs by applying the second set of LLM recovery and utilizing a second LLM model.

In another aspect of the invention, there is a computer system comprising a processor set, one or more computer-readable storage media, and program instructions stored on the one or more computer-readable storage media to cause the processor set to perform operations comprising: receiving raw data from an external application; creating a first set of structured log data by removing noise from the received raw data; performing event merging of the created first set of structured log data; performing pattern extraction on the event merged first set of structured log data; creating sparse log data by performing field reduction on the pattern extracted first set of structured log data; creating compressed logs by applying a first set of LLM compression on the sparse log data; creating a second set of structured log data by extracting key components and organizing data of the compressed logs; and creating recovered logs by applying a second set of LLM recovery on the second set of structured log data. Further embodiments of the present invention include the first server being different from the second server, and the interruption including an abnormal failure of the first server. In particular, embodiments may provide a technical improvement of efficiently compressing, managing, and recovering log data using sparsity processing and LLM techniques.

Aspects of the present invention relate to compressing and efficiently managing operating system log data. Embodiments of the present invention reduce storage requirements while preserving the ability to recover and interpret the original log data accurately. Further embodiments of the present invention provide a method for compressing and recovering log data, such as syslog and operlog data. However, embodiments are not limited to syslog and operlog data, and can be utilized for all types of log data within the mainframe operating system environment. Further embodiments of the present invention utilize a combination of sparsity processing and LLMs.

Embodiments of the present invention utilize the sparsity algorithms to reduce log volume by merging similar events, extracting patterns, and eliminating redundant fields. Further embodiments of the present invention utilize the LLMs to compress the logs by analyzing context and applying advanced compression techniques. Aspects of the present invention utilize a recovery process to leverage the LLMs to reconstruct the original logs from the compressed data by ensuring data integrity and usability.

Aspects of the present invention compress and recover syslog and operlog data by utilizing sparsity algorithms and the LLMs. Accordingly, implementations of the present invention address the high volume of log data generated by mainframe operating systems to ensure efficient storage management and accurate data recovery.

Embodiments of the present invention utilize the LLM for log data recovery and achieve high accuracy of the log data recovery (e.g., 95% or greater accuracy). Accordingly, implementations of the present invention utilize the LLM to effectively capture and reconstruct major events and context of the log data. In further embodiments, the LLM utilizes training data, such as extensive historical log data and detailed entries from a knowledge center, to improve accuracy to a high level (e.g., greater than 95% accuracy). In addition, further aspects of the present invention utilize a recovery process to retain critical information and context.

Aspects of the present invention improve storage resource efficiency and reduce log data volume by applying sparsity algorithms and LLM compression. Embodiments of the present invention provide enhanced data integrity and recovery accuracy by utilizing LLMs to ensure that compressed logs are accurately reconstructed. Further, embodiments of the present invention provide scalability for enterprise level operating system environments by efficiently compressing and recovering large volumes of log data.

Embodiments of the present invention reduce infrastructure and provide cost savings by compressing log data efficiently. Aspects of the present invention improve the operational efficiency of log management operations by improving the ability to search and analyze the compressed logs. Embodiments of the present invention provide versatility and adaptability by compressing and recovering different types of log data within the mainframe operating system environment.

Aspects of the present invention improve data recovery by utilizing LLMs for log compression. Embodiments of the present invention provide improved compression ratios and reliable data recovery by integrating sparsity processing with LLMs.

Embodiments of the present invention provide an efficient system for log compression and accurate data recovery. In contrast, conventional systems have significant storage costs and performance overhead due to a large volume of log data that is generated and processed by mainframe enterprise systems. Further, in conventional systems, log entries often contain redundant and superfluous information, which significantly increases storage costs.

Conventional systems also have complex log data, which contains detailed technical information that requires technical expertise to interpret and manage efficiently. In contrast, embodiments of the present invention reduce storage requirements while preserving the ability to accurately recover and interpret the original log data. Accordingly, implementations of the present invention utilize sparsity algorithms to reduce log volume by merging similar events, extracting patterns, and eliminating redundant fields. Further, aspects of the present invention utilize an LLM to compress log data by analyzing contextual information and applying compression techniques. Implementations of the present invention utilize the LLM to reconstruct the original logs from the compressed data to ensure data integrity and accuracy.

Implementations of the invention are necessarily rooted in computer technology. For example, the steps of creating compressed logs by applying a first set of LLM compression techniques on the sparse log data and creating recovered logs by applying a second set of LLM recovery techniques on the compressed logs are computer-based and cannot be performed in the human mind (or with pen and paper). Applying a first set of LLM compression techniques to create compressed logs and applying a second set of LLM recovery techniques to create recovered logs is, by definition, performed by a computer and cannot practically be performed in the human mind (or with pen and paper). Given this scale and complexity of applying LLM compression and recovery techniques, it is simply not possible for the human mind, or for a person using pen and paper, to perform the number of calculations involved in training and/or using the LLM compression and recovery techniques and LLM models. In further embodiments, the steps of creating the compressed logs by utilizing a first LLM model and creating the recovered logs by utilizing a second LLM model are also rooted in computer technology and cannot be performed in the human mind (or with pen and paper).

Aspects of the present invention include a method, system, and computer program product for compressing log data by integrating sparsity algorithms and LLMs and recovering the compressed log data by utilizing the LLMs. For example, a method includes: log preprocessing by parsing, cleaning, and structuring raw log data; event merging, pattern extraction, and field reduction by utilizing sparsity algorithms; applying LLM techniques for compression of sparse log data; decoding and preparing the compressed logs for recovery; and reconstructing original log data from compressed logs using the LLM techniques. In aspects of the present invention, the method integrates modules into a cohesive system for efficient log compression and accurate recovery.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing.

Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as log compression and recovery code of block 200. In addition to block 200, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and block 200, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

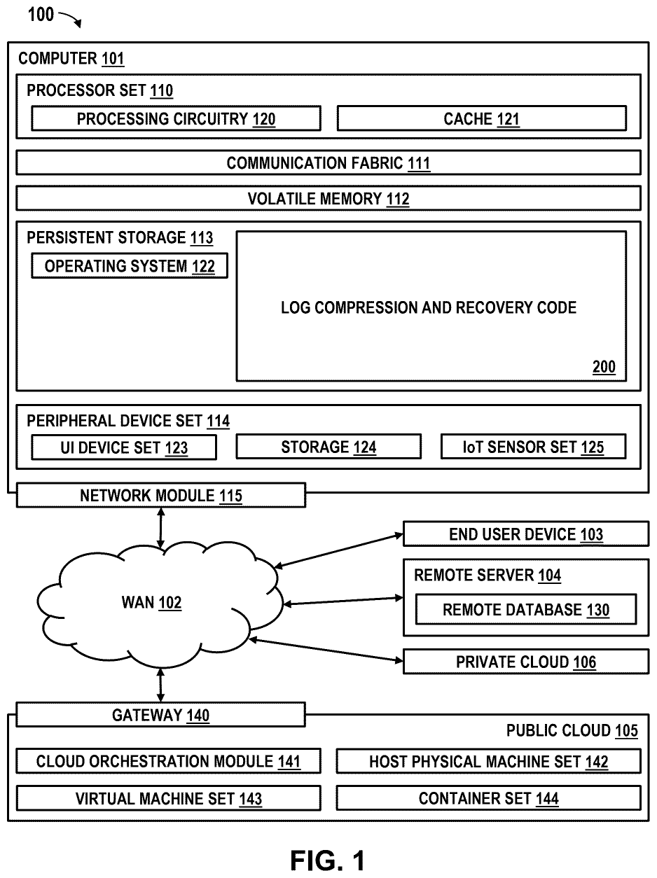

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer-readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer-readable program instructions are stored in various types of computer-readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 200 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 200 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102.

Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer-readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some embodiments, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on a set of APIs. One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

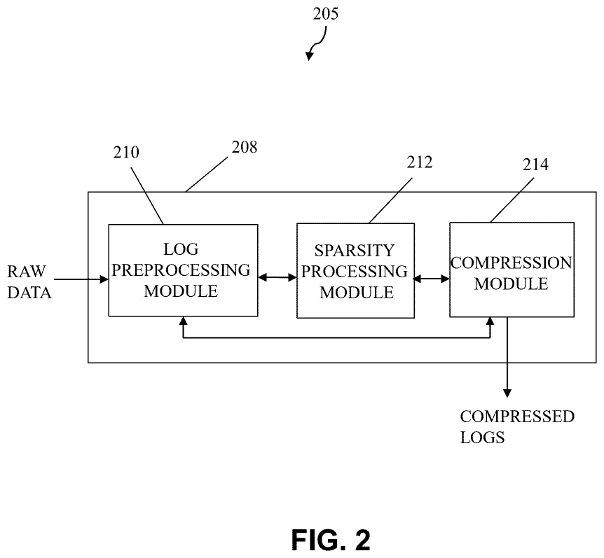

FIG. 2 shows a block diagram of an exemplary environment 205 in accordance with aspects of the invention. In embodiments, the environment 205 includes a log compression server 208, which may comprise one or more instances of the computer 101 of FIG. 1. In other examples, the log compression server 208 comprises one or more virtual machines or one or more containers running on one or more instances of the computer 101 of FIG. 1.

In embodiments, the log compression server 208 of FIG. 2 comprises a log preprocessing module 210, a sparsity processing module 212, and a compression module 214, each of which may comprise modules of the code of block 200 of FIG. 1. Such modules may include routines, programs, objects, components, logic, data structures, and so on that perform particular tasks or implement particular data types that the code of block 200 uses to carry out the functions and/or methodologies of embodiments of the invention as described herein. These modules of the code of block 200 are executable by the processing circuitry 120 of FIG. 1 to perform the inventive methods as described herein. The log compression server 208 may include additional or fewer modules than those shown in FIG. 2. In embodiments, separate modules may be integrated into a single module. Additionally, or alternatively, a single module may be implemented as multiple modules. Moreover, the quantity of devices and/or networks in the environment is not limited to what is shown in FIG. 2. In practice, the environment may include additional devices and/or networks; fewer devices and/or networks; different devices and/or networks; or differently arranged devices and/or networks than illustrated in FIG. 2.

In FIG. 2, and in accordance with aspects of the invention, the log preprocessing module 210 receives raw data from a first external application. In further embodiments of the present invention, the raw data comprises log data, such as syslog data, operlog data, etc., from the first external application. In aspects of the present invention, the first external application comprises a first software application from a mainframe operating system. In embodiments, the raw data comprises historical log data associated with the first software application.

In embodiments, the log preprocessing module 210 extracts key components including a plurality of timestamps, a plurality of log levels, and a plurality of messages from the raw data. In further embodiments, the plurality of log levels refer to a hierarchy of labels assigned to each log entry. For example, the log levels may comprise labels including debug, info, warning, error, and critical. In further embodiments, the plurality of timestamps represent a specific time and data which indicates when an event occurred within a log entry. In aspects of the present invention, the plurality of messages represents individual text entries within a log file, such as events, actions, system status changes, and descriptive information about what happened within the log file.

In aspects of the present invention, the log preprocessing module 210 creates a paired dataset by pairing the raw data comprising the log data with corresponding compressed log data. In embodiments of the present invention, the log preprocessing module 210 incorporates contextual information from a knowledge center into the raw data. For example, the contextual information comprises message help information which is intended to assist in understanding system operations, troubleshooting issues, and providing context about specific events within the mainframe operating system.

In embodiments of the present invention, the log preprocessing module 210 communicates with the compression module 214 to perform initial model training of an LLM based on the raw data and the message help information to understand log structures of the raw data. In further embodiments of the present invention, the log preprocessing module 210 communicates with the compression module 214 to choose the LLM from an LLM list based on the key components of the raw data and a suitability of the LLM for compression tasks. In aspects of the present invention, the LLM list may include a plurality of LLMs which are suitable for training on a large amount of text data. In a non-limiting example, the LLM comprises a pre-trained model such as a generalized language model (GLM). For example, the pre-trained model may be ChatGLM3. In further embodiments, the compression module 214 may choose a different LLM which is suitable for performing compression tasks.

In embodiments, the log preprocessing module 210 also removes noise and normalizes the raw data. In further embodiments, the log preprocessing module 210 removes the noise from the raw data by filtering using moving averages and a median filter, outlier detection and removal, trend and statistical analysis, and signal processing using wavelet denoising and principal component analysis (PCA). In aspects of the present invention, the log preprocessing module 210 normalizes the raw data by calculating a logarithm of each value in the raw data, shifting a logarithmic curve, and adjusting a scale by applying a linear equation to each data point within the raw data.

In embodiments of the present invention, the log preprocessing module 210 creates structured log data after extracting key components, removing noise, and normalizing the raw data. In further embodiments, the log preprocessing module 210 sends the structured log data to the sparsity processing module 212. In aspects of the present invention, the sparsity processing module 212 performs event merging on the structured log data by detecting and combining duplicate or similar events. In embodiments of the present invention, the sparsity processing module 212 reduces the volume of log data. In further aspects of the present invention, the sparsity processing module 212 performs event merging on the structured log data, pattern extraction on the structured log data, and field reduction on the structured log data. In embodiments of the present invention, the events within the structured log data are similar based on having differences within a predetermined threshold. For example, events within the structured log data are similar based on a similarity within the predetermined threshold between relationships and impacts within event data. In further embodiments, the log preprocessing module 210 can also set the predetermined threshold to be within a certain variance (i.e., 5% variance, 10% variance, or 15% variance).

In aspects of the present invention, the sparsity processing module 212 also performs pattern extraction on the structured log data by identifying and generalizing recurring log patterns. In further embodiments, the sparsity processing module 212 performs the pattern extraction by identifying recurring log patterns from text within log entries of the structured log data. In aspects of the present invention, the sparsity processing module 212 generalizes a standardized log pattern based on the recurring log patterns within the structured log data.

In embodiments of the present invention, the sparsity processing module 212 performs field reduction on the structured log data by removing redundant fields and simplifying log entries. The sparsity processing module 212 generates sparse logs after performing event merging, pattern extraction, and field reduction on the structured log data. The sparsity processing module 212 sends the sparse logs to the compression module 214.

In aspects of the present invention, the compression module 214 analyzes a log context of the sparse logs to identify key patterns. For example, the compression module 214 analyzes the log context of the sparse logs to identify specific key patterns such as specific time intervals, specific events, size segments, etc. In this scenario, the compression module 214 identifies key patterns in the sparse logs to prepare the compression module 214 for performing LLM-based compression techniques. In further embodiments, the compression module 214 embeds the contextual information into the sparse logs to prepare the compression module 214 for performing the LLM-based compression techniques.

In embodiments of the present invention, the compression module 214 applies the LLM-based compression techniques to further reduce the data size of the sparse logs. In further embodiments of the present invention, the compression module 214 creates compressed logs based on the LLM-based compression techniques. For example, the LLM-based compression techniques utilize the initially trained LLM for creating the compressed logs. In other words, the LLM-based compression techniques utilize the initially trained LLM to compress the sparse logs by applying advanced compression techniques based on an analysis of the context of the sparse logs and historical sparse logs. In further embodiments, the initially trained LLM comprises a GLM, such as ChatGLM3.

In aspects of the present invention, the compression module 214 performs validation of the initially trained LLM based on an independent dataset. In embodiments of the present invention, the compression module 214 fine-tunes the initially trained LLM using supervised learning techniques and the results of the validation to ensure that the sparsity processing (e.g., event merging, pattern extraction, and redundant field removal) is accurately applied and that the compression efficiency is improved. In aspects of the present invention, the compression module 214 outputs the compressed logs to another application within the mainframe operating system.

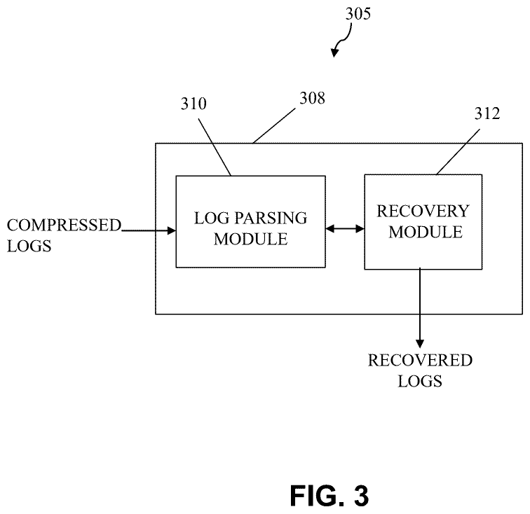

FIG. 3 shows a block diagram of an exemplary environment 305 in accordance with aspects of the invention. In embodiments, the environment 305 includes a log recovery server 308, which may comprise one or more instances of the computer 101 of FIG. 1. In other examples, the log recovery server 308 comprises one or more virtual machines or one or more containers running on one or more instances of the computer 101 of FIG. 1.

In embodiments, the log recovery server 308 of FIG. 3 comprises a log parsing module 310 and a recovery module 312, each of which may comprise modules of the code of block 200 of FIG. 1. In other embodiments of the present invention, the modules of the log compression server 208 and the log recovery server 308 run on a same server.

In FIG. 3, and in accordance with aspects of the invention, the log parsing module 310 receives compressed logs from a second external application. In further embodiments of the present invention, the compressed logs comprise compressed log data, such as compressed syslog data, compressed operlog data, etc., from the second external application. In aspects of the present invention, the second external application comprises a second software application from a mainframe operating system. In other embodiments, the compressed logs are received directly from the compression module 214 in FIG. 2.

In aspects of the present invention, the log parsing module 310 extracts key components from the compressed logs and validates a log structure of the compressed logs. In embodiments of the present invention, the log parsing module 310 extracts key components including timestamps, log levels, the description of the event, contextual specific fields, specific parameters, etc. In further embodiments, the log parsing module 310 validates the log structure of the compressed logs by validating that log data conforms to an expected log structure.

In aspects of the present invention, the log parsing module 310 receives and utilizes the paired dataset of compressed log data with the corresponding raw data. In an example, the log parsing module 310 receives the paired dataset from the log preprocessing module 210. In embodiments of the present invention, the log parsing module 310 also receives the contextual information from the log preprocessing module 210. In other embodiments, the log parsing module 310 receives the contextual information from the knowledge center.

In embodiments of the present invention, the log parsing module 310 communicates with the recovery module 312 to perform initial model training of an LLM based on the raw data and the compressed log data. In further embodiments of the present invention, the log parsing module 310 communicates with the recovery module 312 to choose the LLM based on the raw data and a suitability of the LLM for recovery tasks. In a non-limiting example, the LLM comprises a pre-trained model comprising a GLM. In an example, the pre-trained model may comprise ChatGLM3. In further embodiments, the recovery module 312 may choose a different LLM which is suitable for performing recovery tasks.

In embodiments of the present invention, the log parsing module 310 organizes data from the compressed logs to prepare the compressed logs for LLM-based recovery and generates structured data based on the organized data. For example, the log parsing module 310 organizes data from the compressed logs based on the extracted key components (e.g., timestamps, log levels, the description of the event, contextual specific fields, specific parameters, etc.) to prepare the compressed logs for the LLM-based recovery and generate the structured data. The log parsing module 310 sends the generated structured data to the recovery module 312.

In aspects of the present invention, the recovery module 312 analyzes a context of log entries within the structured data. In further embodiments, the recovery module 312 embeds the contextual information into the structured data to prepare the recovery module 312 for performing the LLM-based recovery. The recovery module 312 applies the LLM-based recovery techniques to rebuild original logs from the structured data to create recovered logs. In other words, the LLM-based recovery techniques utilize the initially trained LLM to recover logs by applying advanced recovery techniques based on an analysis of the context of the log entries within the structured data and historical structured data. For example, the LLM-based recovery techniques utilize the initially trained LLM for creating the recovered logs. In further embodiments, the initially trained LLM comprises a GLM, such as ChatGLM3.

In aspects of the present invention, the recovery module 312 performs validation of the initially trained LLM based on an independent dataset. In embodiments of the present invention, the recovery module 312 fine-tunes the initially trained LLM using supervised learning techniques and the results of the validation to ensure an accuracy of reconstructing original log data from the compressed logs and a contextually rich recovery. The recovery module 312 outputs the recovered logs to another application within the mainframe operating system.

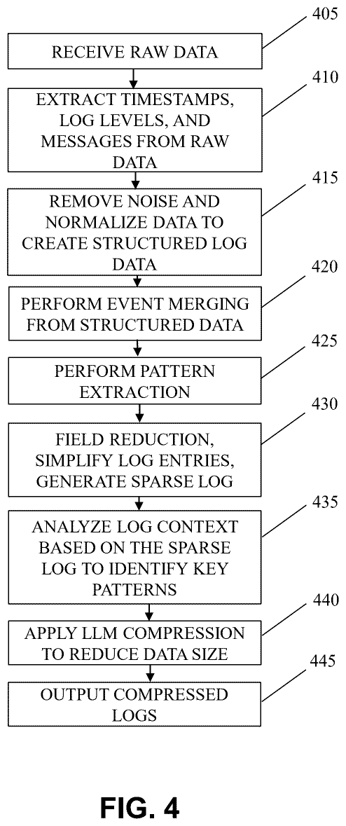

FIG. 4 shows a flowchart of an exemplary method of the compression log server in accordance with aspects of the present invention. Steps of the method may be carried out in the environment of FIG. 2 and are described with reference to elements depicted in FIG. 2.

At step 405, the system receives, at the log preprocessing module 210, raw data from a first external application. In embodiments and as described with respect to FIG. 2, the raw data comprises log data, such as syslog data, operlog data, etc., from the first external application. At step 410, the system extracts, at the log preprocessing module 210, a plurality of timestamps, a plurality of log levels, and a plurality of messages from the raw data. At step 415, the system removes, at the log preprocessing module 210, noise and normalizes the raw data to create structured log data. In embodiments and as described with respect to FIG. 2, the log preprocessing module 210 removes the noise from the raw data by filtering and normalizes the raw data by calculating a logarithm of each value in the raw data. In embodiments and as described with respect to FIG. 2, the log preprocessing module 210 sends the structured log data to the sparsity processing module 212.

At step 420, the system performs, at the sparsity processing module 212, event merging from the structured data. At step 425, the system performs, at the sparsity processing module 212, pattern extraction on the structured data by identifying and generalizing recurring log patterns. At step 430, the system performs, at the sparsity processing module 212, field reduction on the structured log data, simplifies log entries on the structured log data, and generates sparse logs. In embodiments and as described with respect to FIG. 2, the sparsity processing module 212 sends the sparse logs to the compression module 214.

At step 435, the system analyzes, at the compression module 214, a log context of the sparse logs to identify key patterns. In embodiments and as described in FIG. 2, the compression module 214 identifies the key patterns in the sparse logs to prepare the compression module 214 for performing LLM-based compression techniques. At step 440, the system applies, at the compression module 214, the LLM-based compression techniques to further reduce the data size of the data logs to create compressed logs. At step 445, the system outputs, at the compression module 214, the compressed logs.

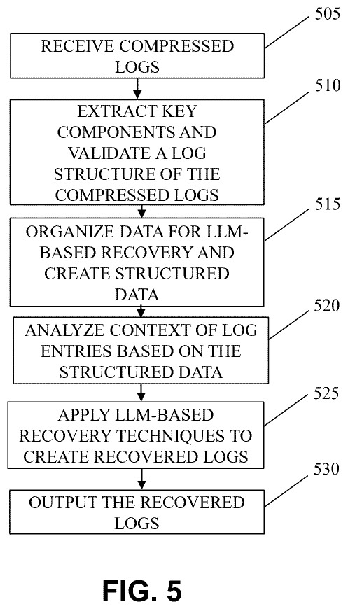

FIG. 5 shows a flowchart of an exemplary method of the recovery log server in accordance with aspects of the present invention. Steps of the method may be carried out in the environment of FIG. 3 and are described with reference to elements depicted in FIG. 3.

At step 505, the system receives, at the log parsing module 310, compressed logs from a second external application. In embodiments and as described with respect to FIG. 3, the compressed logs comprise compressed log data, such as compressed syslog data, compressed operlog data, etc. At step 510, the system extracts, at the log parsing module 310, key components from the compressed logs and validates a log structure of the compressed logs. At step 515, the system organizes, at the log parsing module 310, data from the compressed logs for LLM-based recovery and creates structured data based on the organized data. In embodiments and as described with respect to FIG. 3, the log parsing module 310 sends the structured data to the recovery module 312.

At step 520, the system analyzes, at the recovery module 312, a context of log entries within the structured data. At step 525, the system applies, at the recovery module 312, LLM-based recovery techniques to rebuild original logs from the structured data to create recovered logs. At step 530, the system outputs, at the recovery module 312, the recovered logs.

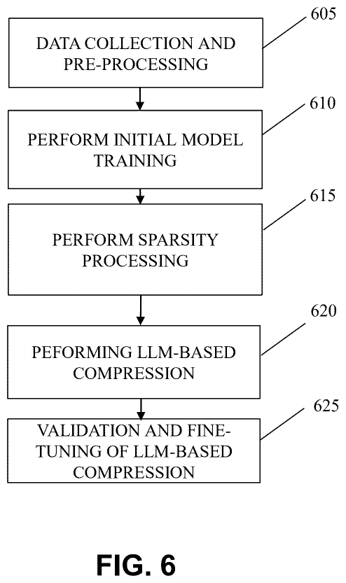

FIG. 6 shows a flowchart of an exemplary method of the compression log server in accordance with aspects of the present invention. Steps of the method may be carried out in the environment of FIG. 2 and are described with reference to elements depicted in FIG. 2.

At step 605, the system performs, at the log preprocessing module 210, data collection and pre-processing. In embodiments and as described with respect to FIG. 2, the log preprocessing module 210 performs data collection and pre-processing by receiving raw data from a first external application and receiving message help information from a knowledge center. At step 610, the system performs, at the log preprocessing module 210, initial model training. In embodiments and as described with respect to FIG. 2, the log preprocessing module 210 communicates with the compression module 214 to perform the initial model training of an LLM based on the raw data and the message help information.

At step 615, the system performs, at the sparsity processing module 212, sparsity processing on structured log data from the log preprocessing module 210. In embodiments and as described with respect to FIG. 2, the sparsity processing module 212 performs sparsity processing by performing pattern extraction, field reduction, and simplifying log entries to generate sparse logs. In embodiments and as described with respect to FIG. 2, the sparsity processing module 212 sends the sparse logs to the compression module 214.

At step 620, the system performs, at the compression module 214, LLM-based compression techniques to further reduce the data size of the sparse logs and creates compressed logs. In embodiments and as described with respect to FIG. 2, the compression module 214 performs the LLM-based compression techniques by utilizing the initially trained LLM for creating the compressed logs.

At step 625, the system performs, at the compression module 214, validation of the initially trained LLM based on an independent dataset and fine-tunes the initially trained LLM using supervised learning techniques. In embodiments and as described with respect to FIG. 2, the compression module 214 fine-tunes the initially trained LLM using supervised learning techniques and the result of the validation. The compression module 214 fine-tunes the initially trained LLM using the supervised learning techniques and the result of the validation to ensure that the sparsity algorithms (i.e., sparsity processing) are accurately applied and that the compression efficiency is improved.

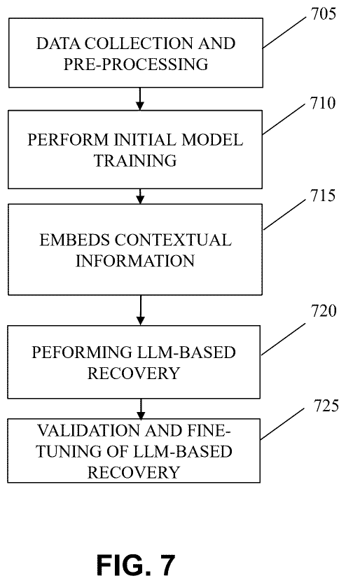

FIG. 7 shows a flowchart of an exemplary method of the compression log server in accordance with aspects of the present invention. Steps of the method may be carried out in the environment of FIG. 3 and are described with reference to elements depicted in FIG. 3.

At step 705, the system performs, at the log parsing module 310, data collection and pre-processing. In embodiments and as described with respect to FIG. 3, the log parsing module 310 performs data collection and pre-processing by receiving compressed logs from a first external application and receiving message help information from a knowledge center. At step 710, the system performs, at the log parsing module 310, initial model training. In embodiments and as described with respect to FIG. 3, the log parsing module 310 communicates with the recovery module 312 to perform the initial model training of an LLM based on the raw data and the compressed log data.

At step 715, the system embeds, at the recovery module 312, contextual information into the structure data to prepare the recovery module 312 for performing LLM-based recovery. At step 720, the system performs, at the recovery module 312, the LLM-based recovery by applying LLM-based recovery techniques to rebuild original logs from the structured data to create recovered logs. In embodiments and as described with respect to FIG. 3, the recovery module 312 performs the LLM-based recovery by utilizing the initially trained LLM for creating the recovered logs.

At step 725, the system performs, at the recovery module 312, validation of the initially trained LLM based on an independent dataset and fine-tunes the initially trained LLM using supervised learning techniques. In embodiments and as described with respect to FIG. 3, the recovery module 312 fine-tunes the initially trained LLM using supervised learning techniques and the result of the validation. The recovery module 312 fine-tunes the initially trained LLM using the supervised learning techniques and the result of the validation to ensure an accuracy of reconstructing original log data from the compressed logs and a contextually rich recovery.

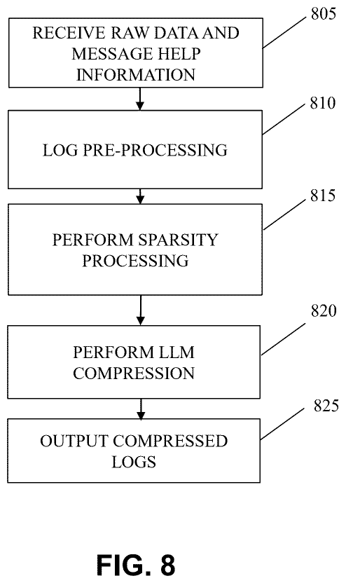

FIG. 8 shows a flowchart of an exemplary method of the compression log server in accordance with aspects of the present invention. Steps of the method may be carried out in the environment of FIG. 2 and are described with reference to elements depicted in FIG. 2.

At step 805, the system receives, at the log preprocessing module 210, raw data and message help information from a knowledge center. At step 810, the system performs, at the log preprocessing module 210, log parsing by extracting key components, removing noise, and normalizing the raw data. In embodiments and as described with respect to FIG. 2, the log preprocessing module 210 creates structured log data and sends the structured log data to the sparsity processing module 212.

At step 815, the system performs, at the sparsity processing module 212, sparsity processing on the structured log data. In embodiments and as described with respect to FIG. 2, the sparsity processing module 212 performs sparsity processing by performing pattern extraction, field reduction, and simplifying log entries to generate sparse logs. In embodiments and as described with respect to FIG. 2, the sparsity processing module 212 sends the sparse logs to the compression module 214.

At step 820, the system performs, at the compression module 214, LLM compression to further reduce the data size of the sparse logs and creates compressed logs. In embodiments and as described with respect to FIG. 2, the compression module 214 performs the LLM-based compression techniques by utilizing the initially trained LLM for creating the compressed logs. At step 825, the system outputs, at the compressed module 214, the compressed logs.

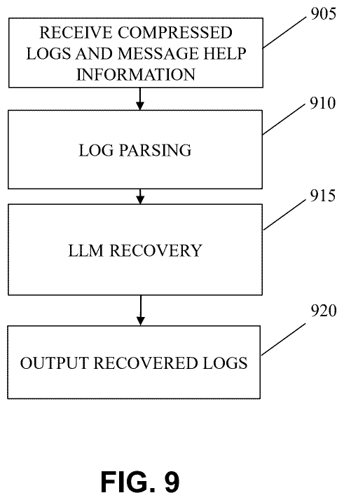

FIG. 9 shows a flowchart of an exemplary method of the compression log server in accordance with aspects of the present invention. Steps of the method may be carried out in the environment of FIG. 3 and are described with reference to elements depicted in FIG. 3.

At step 905, the system receives, at the log parsing module 310, data collection and pre-processing. In embodiments and as described with respect to FIG. 3, the log parsing module 310 performs data collection and pre-processing by receiving compressed logs from a second external application and receiving message help information from a knowledge center. At step 910, the system performs, at the log parsing module 310, log parsing by extracting key components and organizing data from the compressed logs to create structured data.

At step 915, the system performs, at the recovery module 312, LLM recovery to rebuild original logs from the structured data to create recovered logs. In embodiments and as described with respect to FIG. 3, the recovery module 312 performs the LLM-based recovery techniques by utilizing the initially trained LLM for creating the recovered logs. At step 920, the system outputs, at the recovery module, the recovered logs.

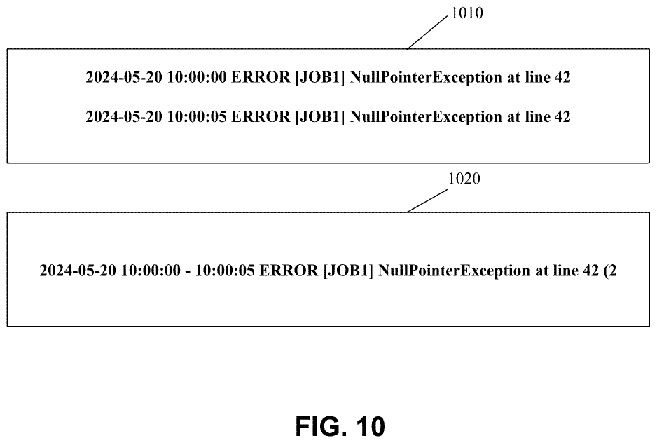

FIG. 10 shows an event merging example in accordance with aspects of the present invention. In FIG. 10, original logs 1010 include a first log (“2024-05-20 10:00:00 ERROR [JOB 1] NullPointerException at line 42”) and a second log (“2024-05-20 10:00:05 ERROR [JOB 1] NullPointerException at line 42”). In embodiments of the present invention, the sparsity processing module 212 performs event merging on the original logs 1010 by detecting and combining similar events into a combined log 1020. As shown in FIG. 10, the combined log 1020 includes the common information in the first and second logs of the original logs 1010 with a combined timestamp ('10: 00:00-10:00:05”) of the first and second logs of the original logs 1010.

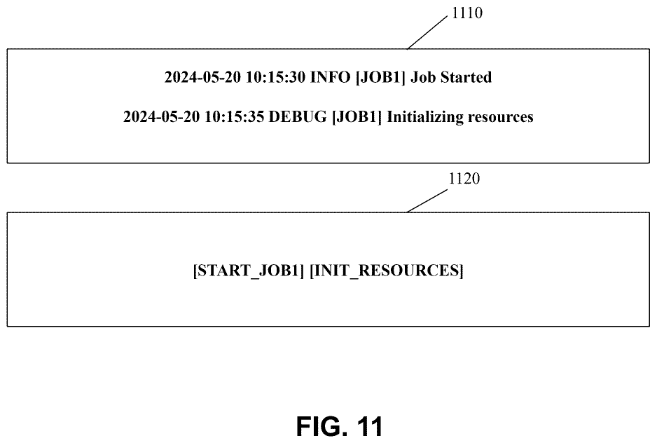

FIG. 11 shows a pattern extraction example in accordance with aspects of the present invention. In FIG. 11, original logs 1110 include a first log (“2024-05-20 10:15:30 INFO [JOB 1] Job Started”) and a second log (“2024-05-20 10:15:35 DEBUG [JOB 1] Initializing resources”). In embodiments of the present invention, the sparsity processing module 212 performs pattern extraction on the original logs 1110 by identifying and generalizing a recurring log pattern 1120. As shown in FIG. 11, the recurring log pattern 1120 includes a recurring log pattern (“START_JOB1”, “INIT_RESOURCES”) from text within log entries of the original logs 1110.

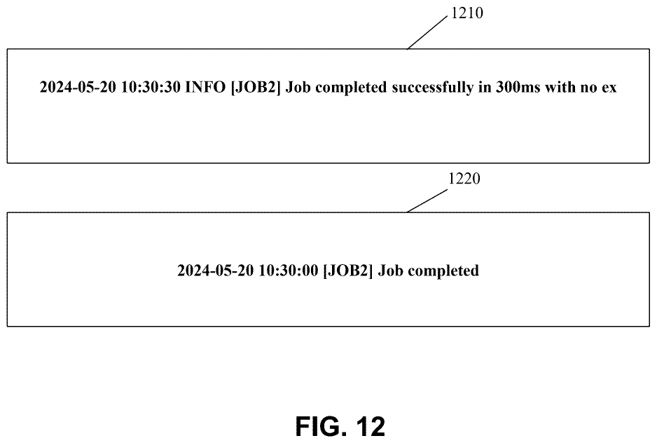

FIG. 12 shows a field reduction example in accordance with aspects of the present invention. In FIG. 12, an original log 1210 includes “2024-05-20 10:30:30 INFO [JOB 2] Job completed successfully in 300 ms with no ex”. In embodiments of the present invention, the sparsity processing module 212 performs field reduction on the original log 1210 by removing redundant fields and simplifying log entries in the reduced log 1220. As shown in FIG. 12, the reduced log 1220 includes simplified text “2024-05-20 10:30:00[JOB 2 ] Job completed” which is a field reduction of the original log 1210.

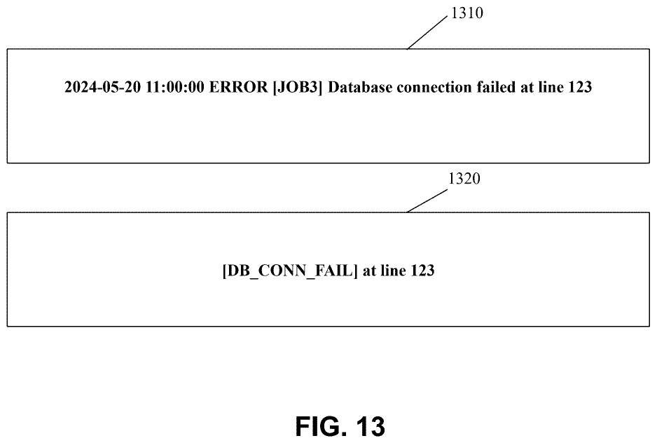

FIG. 13 shows an example of compression in accordance with aspects of the present invention. In FIG. 13, an original log 1310 includes “2024-05-20 11:00:00 ERROR [JOB 3] Database connection failed at line 123”. In embodiments of the present invention, the compression module 214 compresses the original log 1310 to create a compressed log 1320 based on LLM-based compression techniques. For example, the LLM-based compression techniques utilize the initially trained LLM for creating the compressed log 1320. In further embodiments, the initially trained LLM comprises a GLM, such as ChatGLM3.

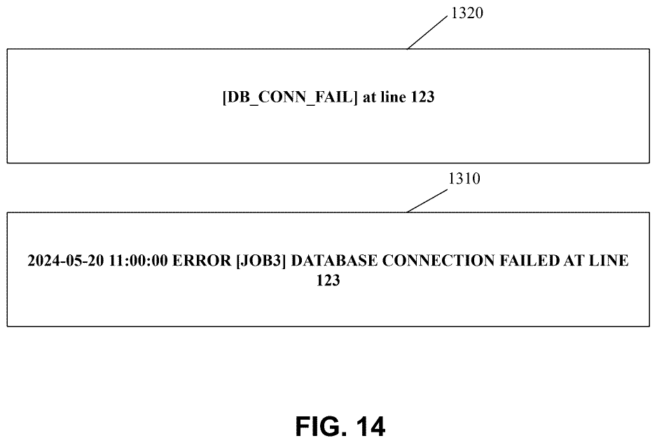

FIG. 14 shows an example of recovery in accordance with aspects of the present invention. In FIG. 14, the recovery module 312 applies the LLM-based recovery techniques to rebuild the original log from the compressed log 1320 to create the original log 1310 (i.e., the recovered log). For example, the LLM-based recovery utilizes the initially trained LLM for creating the original log 1310. In further embodiments, the initially trained LLM comprises a GLM, such as ChatGLM3.

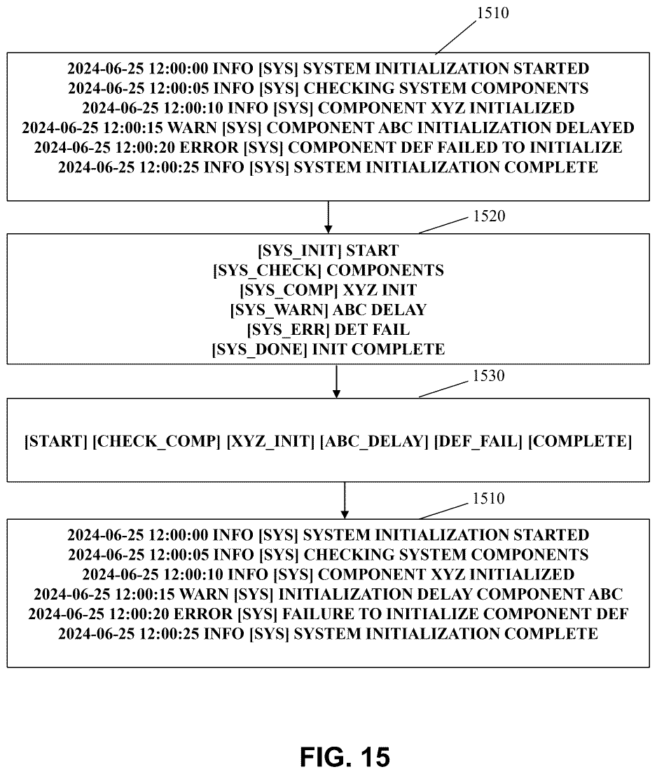

FIG. 15 shows an example of compression and recovery in accordance with aspects of the present invention. In FIG. 15, the sparsity processing module 212 performs sparsity processing (e.g., performing pattern extraction, field reduction, and simplifying log entries) on original logs 1510 to generate sparse logs 1520. In embodiments of the present invention, the compression module 214 applies the LLM-based compression techniques on the sparse logs 1520 to create compressed logs 1530. In further embodiments, the recovery module 312 applies the LLM-based recovery techniques to recover the original logs 1510 (i.e., the recovered logs).

In embodiments, a service provider could offer to perform the processes described herein. In this case, the service provider can create, maintain, deploy, support, etc., the computer infrastructure that performs the process steps of the invention for one or more customers. These customers may be, for example, any business that uses technology. In return, the service provider can receive payment from the customer(s) under a subscription and/or fee agreement and/or the service provider can receive payment from the sale of advertising content to one or more third parties.

In still additional embodiments, the invention provides a computer-implemented method, via a network. In this case, a computer infrastructure, such as computer 101 of FIG. 1, can be provided and one or more systems for performing the processes of the invention can be obtained (e.g., created, purchased, used, modified, etc.) and deployed to the computer infrastructure. To this extent, the deployment of a system can comprise one or more of: (1) installing program code on a computing device, such as computer 101 of FIG. 1, from a computer readable medium; (2) adding one or more computing devices to the computer infrastructure; and (3) incorporating and/or modifying one or more existing systems of the computer infrastructure to enable the computer infrastructure to perform the processes of the invention.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method, comprising:
receiving raw data from an external application;
creating structured log data by removing noise from the received raw data, wherein the removing the noise includes normalizing the received raw data by calculating a logarithm of each value in the received raw data;
performing event merging on the structured log data by combining similar log events into a combined log, wherein the similarity between the log events is determined based on a predefined threshold;
performing pattern extraction on the event merged structured log data;
creating sparse log data by performing field reduction on the pattern extraction;
reducing a size of the sparse log data by creating compressed logs, wherein the compressed logs are created by applying a first set of large language model (LLM) compression on the sparse log data; and
validating a log structure of the compressed logs.

2. The method of claim 1, wherein the external application comprises a software application from a mainframe operating system.

3. The method of claim 1, wherein the received raw data comprises log data.

4. The method of claim 3, wherein the log data comprises syslog data.

5. The method of claim 3, wherein the log data comprises operlog data.

6. The method of claim 1, further comprising extracting at least one of a timestamp, a log level, and a message from the received raw data.

7. The method of claim 1, wherein the performing the event merging on the structured log data comprises detecting and combining duplicate events within the structured log data.

8. (canceled)

9. The method of claim 1, wherein the performing the pattern extraction comprises identifying recurring log patterns from text within log entries of the event merged structured log data.

10. The method of claim 1, wherein the performing the field reduction on the pattern extraction comprises removing redundant fields from the pattern extraction.

11. The method of claim 1, wherein the creating the compressed logs by applying the first set of LLM compression comprises utilizing a first LLM model on the sparse log data.

12. The method of claim 11, wherein the first LLM model comprises a generalized language model (GLM).

13. The method of claim 1, further comprising:
creating recovered logs by applying a second set of LLM recovery, wherein the creating the recovered logs comprises utilizing a second LLM model on the compressed logs.

14. The method of claim 13, wherein the second LLM model comprises a generalized language model (GLM).

15. A computer program product comprising:
one or more computer-readable storage media; and
program instructions stored on the one or more computer-readable storage media to perform operations comprising:
receiving raw data from an external application;
creating structured log data by removing noise from the received raw data. wherein the removing the noise includes normalizing the received raw data by calculating a logarithm of each value in the received raw data;
performing event merging on the structured log data by combining similar log events into a combined log, wherein the similarity between the log events is determined based on a predefined threshold;
performing pattern extraction on the event merged structured log data;
creating sparse log data by performing field reduction on the pattern extraction;
reducing a size of the sparse log data by creating compressed logs, wherein the compressed logs are created by applying a first set of large language model (LLM) compression on the sparse log data; and
validating a log structure of the compressed logs.

16. The computer program product of claim 15, wherein the performing the event merging of the structured log data comprises detecting and combining duplicate events within the structured log data.

17. (canceled)

18. The computer program product of claim 15, wherein:
the performing the pattern extraction comprises identifying recurring log patterns from text within log entries of the event merged structured log data; and
the performing the field reduction on the pattern extraction comprises removing redundant fields from the pattern extraction.

19. The computer program product of claim 15, further comprising:
utilizing a first LLM model on the sparse log data for creating the compressed logs; and
utilizing a second LLM model on the compressed logs for recovering logs.

20. A computer system comprising:
a processor set;
one or more computer-readable storage media; and
program instructions stored on the one or more computer-readable storage media to cause the processor set to perform operations comprising:
receiving raw data from an external application;
creating a first set of structured log data by removing noise from the received raw data;
performing event merging on the first set of structured log data;
performing pattern extraction on the event merged first set of structured log data;
creating sparse log data by performing field reduction on the pattern extraction;
creating compressed logs by applying a first set of large language model (LLM) compression on the sparse log data;
creating a second set of structured log data by extracting key components and organizing data of the compressed logs; and
creating recovered logs by applying a second set of LLM recovery on the second set of structured log data.
